(19) United States
(12) Patent Application Publication
(10) Pub. No.: US 2019/0016858 A1
(43) Pub. Date: Jan. 17, 2019

(54) PROCESS FOR PREPARING POLYMERIC IMIDAZOLIUM COMPOUNDS WITHOUT OR WITH LESS MONOALDEHYDE

(71) Applicant: BASF SE, Ludwigshafen am Rhein (DE)

(72) Inventor: Jean-Pierre Berkan LINDNER, Mannheim (DE)

(73) Assignee: BASF SE, Ludwigshafen am Rhein (DE)

(21) Appl. No.: 16/066,441

(22) PCT Filed: Jan. 3, 2017
(86) PCT No.: PCT/EP2017/050054

§ 371 Date: Jun. 27, 2018

(30) Foreign Application Priority Data
Jan. 12, 2016 (EP) 16150951.8

(51) Int. Cl. C08G 73/06; C08G 12/06

(52) U.S. Cl. CPC C08G 73/0616; C08G 12/06

(57) ABSTRACT

A process for preparing polymeric compounds comprising ionic imidazolium groups (polymeric imidazolium compounds for short) comprising reacting —an α-dicarbonyl compound, —an amino compound having at least two primary amino groups (referred to as oligoamine), —a protic acid, —less than 1 mol of a compound with only one aldehyde group (referred to as monoaldehyde) per mol of oligoamine and —optionally further compounds.

The invention relates to a process for preparing polymeric compounds comprising ionic imidazolium groups (polymeric imidazolium compounds for short) which comprises reacting
an α-dicarbonyl compound,
an amino compound having at least two primary amino groups (referred to as oligoamine),
a protic acid,
less than 1 mol of a compound with only one aldehyde group (referred to as mono-aldehyde) per mol of oligoamine and
optionally further compounds

Polymeric imidazolium compounds and processes for preparing them are described for example in WO 99/37276. According to WO 99/37276 polymeric imidazolium compounds are obtained by reaction compounds having two imidazole groups with dibromo compounds. The cationic imidazolium polymers obtained have bromide anions as counterion.

From WO 2010/072571 a new process for preparing polymeric imidazolium compounds is known. According to WO 2010/072571 an α-dicarbonyl compound, an aldehyde, a diamine and a protic acid are reacted. In only one reaction step both, the imidazolium ring system and the polymeric imidazolium are obtained from such starting materials. The process of WO 2010/072571 is further described in later patent applications PCT/EP 2015/067104 (PF 77453) and PCT/EP 2015/067101 (PF 77394) which are not yet published.

The above prior art processes of the preparing polymeric imidazolium compounds involve either the use of compounds with halogen atoms or of a mono aldehyde, in particular of formaldehyde. Further alternative processes which are environmentally beneficial and which avoid such starting materials are of interest. Often residual formaldehyde or halogen compounds in polymeric imidazolium compounds are not tolerated in a number of technical applications, in particular in the fields of electronics, home care and cosmetics.

It was an object of the present invention to find a new process to the prior art processes for the production of polymeric imidazolium compounds. In particular the new process should be economical and environmentally beneficial.

Accordingly, the process as defined above has been found.

To the starting compounds for the process

According to the invention, an α-dicarbonyl compound, an oligo-amine, a protic acid, less than 1 mol of a mono-aldehyde and optionally further compounds are reacted with one another.

In the following the wording “α-dicarbonyl compound” shall include also a mixture of α-dicarbonyl compound, “oligo-amine” shall include also a mixture of oligo-amines, “protic acid” shall include also a mixture of protic acids, “mono-aldehyde” shall include a mixture of mono-aldehydes.

The carbonyl groups of the α-dicarbonyl compound and the mono aldehyde may have also the form of a hemiacetal, acetal, hemiketal or ketal group, which are usual protecting groups.

The reaction is a polycondensation. In a polycondensation polymerization occurs with elimination of a low molecular weight compound such as water or alcohol. Water is eliminated in case of carbonyl groups. In case that the carbonyl groups are protected and have the form of a ketal or hemiketal, acetal or hemiacetal group, an alcohol is eliminated instead of water.

In a preferred embodiment of the present invention the carbonyl groups are present as such and do not have the form of a hemiacetal, acetal, hemiketal or ketal group.

The term α-dicarbonyl compound, oligo-amine, mono-aldehyde or protic acid as used herein includes a mixture of various-dicarbonyl compounds, of various oligo-amines, various mono-aldehydes or various protic acids.

To the α-dicarbonyl compound The α-dicarbonyl compound is preferably a compound of the formula I

R1-CO—CO—R2,

where R1 and R2 are each, independently of one another, a hydrogen atom, a hydroxy group or an organic radical having from 1 to 20 carbon atoms. The organic radicals may be branched or unbranched or comprise functional groups which can, for example, contribute to further crosslinking of the polymeric imidazolium compound. Preferably, the organic radical is an aliphatic or aromatic hydrocarbon with 1 to 10 carbon atoms and hence does not comprise any other atoms than carbon and hydrogen.

In a preferred embodiment, at least one of R1 and R2 is a hydrogen or a hydroxy group.

In a more preferred embodiment, R1 and R2 are each, independently of one another, an H atom or a hydroxy group.

Preferred compounds are, in particular compound with the following meanings of R1 and R2
R1=H and R2=aliphatic or aromatic hydrocarbon with 1 to 10 carbon atoms,
R1=H and R2=OH,
R1=OH and R2=OH and
R1=H and R2=H

Most preferably the α-dicarbonyl compound is glyoxal (R1 and R2 are each hydrogen) or glyoxylic acid (R1 is hydrogen and R2 is hydroxyl) or mixtures thereof; particularly preferred is glyoxylic acid.

To the oligo-amine

The oligo-amine may preferably be represented by the general formula II

(NH₂—)ₙR3

where n is an integer greater than or equal to 2 and indicates the number of amino groups. n can assume very large values, e.g. n can be an integer from 2 to 10 000, in particular from 2 to 5000. Very high values of n are present, for example, when polyamines such as polyvinylamine are used.

When compounds having n=2 (diamines) are used in the reaction according to the invention, linear, polymeric imidazolium compounds are formed, while in the case of amines having more than two primary amino groups, branched polymers are formed.

In a preferred embodiment, n is an integer from 2 to 6, in particular from 2 to 4. Very particular preference is given to n=2 (diamine) or n=3 (triamine). Very particular preference is given to n=2.

R3 is any n-valent organic radical. The n-valent organic radical can be the radical of a polymer, e.g. a polyvinylamine as mentioned above, and then has a correspondingly high molecular weight.

The organic radical can comprise not only carbon and hydrogen but also heteroatoms such as oxygen, nitrogen, sulfur or halogens, e.g. in the form of functional groups such as hydroxyl groups, acid groups, such as carboxylic acid groups, ether groups, ester groups, amide groups, aromatic heterocycles, keto groups, aldehyde groups, primary or secondary amino groups, imino groups, thioether groups or halide groups.

In a preferred embodiment, the amino compound may comprise ether groups, secondary or tertiary amino groups, carboxylic acid groups and apart from these no further functional groups. Mention may be made of, for example, polyether amines.

R3 is most preferably a pure hydrocarbon radical or a hydrocarbon radical interrupted or substituted by ether groups, secondary amino groups or tertiary amino groups. In a particular embodiment, R3 is a pure hydrocarbon radical and does not comprise any functional groups. The hydrocarbon radical can be aliphatic or aromatic or comprise both aromatic and aliphatic groups.

Oligo-amines may for example be diamines, in which the primary amino groups are bound directly to an aliphatic group, an aromatic ring system, e.g. a phenylene or naphthylene group, or amino compounds in which the primary amino groups are bound to aliphatic groups as alkyl substituents of an aromatic ring system.

Particularly preferred oligo-amines are diamines, in which the primary amino groups are bound to an aliphatic hydrocarbon radical, preferably an aliphatic hydrocarbon radical having from 2 to 50 carbon atoms, particularly preferably from 3 to 40 carbon atoms.

Most preferred diamines are C2-C20-alkylenediamines such as 1,4-butylenediamine or 1,6-hexylenediamine.

To the Protic Acid

The protic acid may be represented by the formula Y^{m-} (H⁺)ₘ, where m is a positive integer. It can also be a polymeric protic acid, e.g. polyacrylic acid; in this case, m can assume very high values. As such polymeric protic acids, mention may be made of, for example, polyacrylic acid, polymethacrylic acid or a copolymer of (meth)acrylic acid, maleic acid, fumaric acid or itaconic acid with any other monomers, e.g. with (meth)acrylates, vinyl esters or aromatic monomers such as styrene, or another polymer having a plurality of carboxyl groups.

In a preferred embodiment, m is an integer from 1 to 4, particularly preferably 1 or 2. In a particular embodiment, m is 1.

The anion Y^{m-} of the protic acid forms the counterion to the imidazolium cations of the polymeric imidazolium compound.

The anion of a protic acid is preferably the anion of a protic acid having a pKₐ of at least 1, in particular at least 2 and in a very particularly preferred embodiment at least 4 (measured at 25° C., 1 bar, in water or dimethyl sulfoxide).

The pKₐ is the negative logarithm to the base 10 of the acid constant, Kₐ.

The pKₐ is for this purpose measured at 25° C., 1 bar, either in water or dimethyl sulfoxide as solvent; it is therefore sufficient, according to the invention, for an anion to have the corresponding pKₐ either in water or in dimethyl sulfoxide. Dimethyl sulfoxide is used particularly when the anion is not readily soluble in water. Information on the two solvents may be found in standard reference works.

The protic acid is therefore preferably not a protic acid of the halogens which have a pKₐ of less than 1; in particular, it is not HCl and not HBr and the anion is correspondingly not chloride or bromide.

Preferred protic acids are carboxylic acids, sulfonic acids, phosphoric acids or phosphonic acids.

As phosphoric acid mention may be made of, in particular, compounds of the formula IV

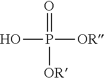

where R′ and R″ are each, independently of one another, hydrogen or a C1-C10-, preferably C1-C4-alkyl group.

As phosphonic acid mention may be made of, in particular, compounds of the formula V

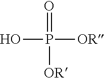

where R′ and R″ are each, independently of one another, hydrogen or a C1-C10-, preferably C1-C4-alkyl group.

Preferably, the protic acid is a carboxylic acid with one or more, in particular with one to three carboxylic acid groups; most preferred are carboxylic acids with one carboxylic acid group.

Preferred carboxylic acids have from 1 to 20 carbon atoms and comprise one or two carboxylic acid groups.

The carboxylic acids may be aliphatic or aromatic compounds. Here, aromatic compounds are compounds comprising aromatic groups. Particular preference is given to aliphatic or aromatic carboxylic acids which apart from the oxygen atoms of the carboxylic acid groups group comprise no further heteroatoms or at most comprise one or two hydroxyl groups, carbonyl groups or ether groups.

Most preferred are aliphatic or aromatic carboxylic acids which comprise no further heteroatoms in addition to the oxygen atoms of the carboxylic acid group.

As carboxylic acid having two carboxylic acid groups for example phthalic acid, isophthalic acid, of C2-C6-dicarboxylic acids, e.g. oxalic acid, malonic acid, succinic acid, glutaric acid, adipic acid may be mentioned.

As carboxylic acid having one carboxylic acid group, mention may be made of aliphatic, aromatic, saturated or unsaturated C1-C20-carboxylic acids, in particular alkanecarboxylic acids, alkenecarboxylic acids, alkynecarboxylic acids, alkadienecarboxylic acids, alkatrienecarboxylic acids, hydroxycarboxylic acids or ketonecarboxylic acids or aromatic carboxylic acids such as benzoic acid or phenylacetic acid. Suitable alkanecarboxylic acids, alkenecarboxylic acids and alkadienecarboxylic acids are also known as fatty acids.

Examples are benzoic acid and C1-C20-alkanecarboxylic acids, which may optionally be substituted by one or two hydroxy groups, preferably one hydroxy group.

Particular preference given to the benzoic acid and C2-C20-alkanecarboxylic acids, in particular the acetic acid and propionic acid, with very particular preference being given to acetic acid.

To the mono-aldehyde The mono-aldehyde may be represented by formula III

R4-CHO,

where R4 is an H atom or an organic radical having from 1 to 20 carbon atoms. Particular preference is given to formaldehyde; the formaldehyde can also be used in the form of compounds which liberate formaldehyde, e.g. paraformaldehyde or trioxane.

The mono-aldehyde is used in amounts of less than 1 mol per mol of oligo-amine.

Preferably the mono-aldehyde is used in amounts less of than 0.1 mol mono-aldehyde per mol of oligo-amine.

Most preferably no mono-aldehyde is used in the process of the present invention.

Hence, in the most preferred embodiment of the invention the reaction solution and the obtained polymeric imidazolium compounds are free of mono-aldehydes and in particular free of formaldehyde.

To Further Compounds

In the process of the invention, it is possible to use further compounds, e.g. in order to introduce specific end groups into the polymer or bring about additional crosslinking by means of further functional groups, to set defined properties or to make further reactions on the resulting polymer (polymer-analogous reactions) at a later point in time possible.

Thus, if desired, it is possible to use, for example, monoamines in order to influence the molecular weight of the polymeric imidazolium compounds. The compound having only one primary amino group leads to chain termination and then forms the end group of the polymer chain concerned. The higher the proportion of the monoamine, the lower is the molecular weight.

To the Process:

The reaction without mono-aldehyde proceeds in principle according to the following reaction scheme:

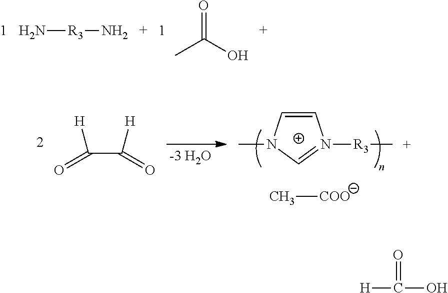

Here, one molecule of a diamine, one molecule of the acetic acid and two molecules of the α-dicarbonyl compound are reacted to give the polymeric imidazolium compound with acetic anions. Due to the use of glyoxal, formic acid is obtained as by-product. If glyoxylic acid is used as α-dicarbonyl compound instead, carbon dioxide will be formed as by-product. This leads to the assumption that both of the two α-dicarbonyl molecules contribute to the formation of the imidazolium ring system, one forming the two carbon atoms bridge between the nitrogen atoms and the other α-dicarbonyl molecule forming the one carbon atom bridge between the nitrogen atoms. The latter obviously occurs under splitting of the carbon-carbon bond of the α-dicarbonyl molecule resulting in formic acid respectively carbon dioxide as by-product.

In case that some mono-aldehyde is used as well, some of the one carbon atom bridges between the two nitrogen atoms may be formed from such mono-aldehyde and the others will be formed according to the mechanism set out above.

High molecular weights of the polymeric imidazolium compound may be achieved, for example, if the compounds are used in equimolar amounts, which means that 2 mol of aldehydes in total (being the sum of mono-aldehyde, if any, and α-dicarbonyl compound) are reacted with 1 mol of diamine and one mol of protic acid. In case of oligo-amines with more than two primary amino groups the equivalents of the other compounds have to be adapted accordingly to give equimolar amounts.

Of course any of the compounds may be used in excess, resulting in a quick and complete consumption of the other compounds and a residue of the compound used in excess.

It has been found, however, that the formation of polymeric, ionic imidazolium compounds of high molecular weight is improved with a molar ratio of the aldehyde compounds in total (which are the α-dicarbonyl compound and, optionally, the mono-aldehyde) to the oligo-amine is greater than 2.

In a preferred embodiment the molar ratio the of aldehyde compounds in total to the oligo-amine is from 3.0:1.0 to 2.0:1.0, more preferred is a ratio of 2.2:1.0 to 2.0:1.0.

Preferably, the protic acid is used in at least equimolar amounts.

The reaction of the compounds may be performed in a solvent. Suitable solvents are water or organic solvents, including hydrophilic as well as hydrophobic organic solvents. Hydrophobic organic solvents may in particular be suitable in case of hydrophobic compounds.

The reaction of the compounds is preferably performed in water, a water-miscible solvent or mixtures thereof.

Water-miscible solvents are, in particular, protic solvents, preferably aliphatic alcohols or ethers having not more than 4 carbon atoms, e.g. methanol, ethanol, methyl ethyl ether, tetrahydrofuran. Suitable protic solvents are miscible with water in any ratio (at 1 bar, 21° C.).

The reaction is preferably performed in water or mixtures of water with the above protic solvents. The reaction is particularly preferably performed in water.

During the reaction the pH value is preferably 1 to 7, more preferably 1 to 6 and in particular 3 to 5. The pH value may be kept or adjusted by any suitable manner, for example by adding acids or suitable puffer systems. In a preferred embodiment an excess of the protic acid which is used as starting material may be used to adjust the pH value.

In a preferred embodiment the molar ratio of the protic acid to the oligo-amine may be from 1.05:1 to 10:1, in particular from 1.2:1 to 5:1, respectively 1.5:1 to 5:1.

The compounds may be combined in any order.

The reaction of the compounds can be carried out at, for example, pressures of from 0.1 to 10 bar, in particular atmospheric pressure, and, for example, at temperatures below 100° C., in particular below 50° C., particularly preferably below 40° C., respectively 30° C. The reaction is exothermic and cooling is required. In order to avoid freezing the temperature should preferably not be lower than 0° C., in particular not be lower than 3° C. (at normal pressure). After the exothermic reaction the temperature may be raised and the reaction mixture may be stirred and kept at a higher temperature to complete the reaction.

The reaction can be carried out batchwise, semicontinuously or continuously. In the semicontinuous mode of operation, it is possible, for example, for at least one starting compound to be initially charged and the other compounds to be metered in.

In the continuous mode of operation, the compounds are combined continuously and the product mixture is discharged continuously. The compounds may be fed in either individually or as a mixture of all or any of the compounds used. In a particular embodiment, the oligo-amine and the acid are mixed beforehand and fed in as one stream, while the other compounds can be fed in either individually or likewise as a mixture (2nd stream).

In a further particular embodiment of a continuous process all compounds comprising carbonyl groups (i.e. the α-dicarbonyl compound and the mono-aldehyde, if any; and the protic acid of the anion X,m if the latter is a carboxylate) are mixed beforehand and fed in together as one stream; the remaining oligo-amine or mono-amine are then fed in separately or combined to a second stream.

The continuous preparation can be carried out in any reaction vessels, i.e. in a stirred vessel. It is preferably carried out in a cascade of stirred vessels, e.g. from 2 to 4 stirred vessels, or in a tube reactor.

In a preferred embodiment of a batchwise process the protic acid is placed in the reactor first and the oligo-amine, the α-dicarbonyl compound, mono-aldehyde, if any, are fed to the protic acid in a rate that the temperature of the reaction mixture is kept below 40° C., respectively 30° C. With such procedure the formation of any precipitates during the reaction is essentially avoided.

After the polycondensation reaction has been carried out, the polymeric compounds obtained can precipitate from the solution or remain in solution. Preferably solutions of the polymeric ionic imidazolium compounds are obtained.

The polymeric compounds can also be separated off from the solutions by customary methods. In the simplest case, the solvent, e.g. water, can be removed by distillation or by spray drying.

Mn may be for example greater than 5.000, in particular greater than 10.000, respectively greater than 20.000 g/mol. In general Mn will not be higher than 500.000 g/mol.

The polydispersity (ratio of weight average molecular weight and number average molecular weight Mw/Mn) may have, for example, values of from 1.1 to 100, in particular from 1.5 to 20.

The molecular weight of the polymeric imidazolium compounds is determined by Size-exclusion chromatographie (SEC) using poly(2-vinylpyridine as standard and water comprising 0.1 w/w % trifluoracetic acid and 0.1 mol/1 NaCl as effluent. The temperature of the column is 25° C., the injected volume 100 μL (μliter), the concentration 1.5 mg/mL and the flow rate 0.8 mL/min.

The process of the invention is an easy and cost-effective process to obtain high molecular weight polymeric compounds comprising imidazolium groups. In addition, the process has high selectivity regarding such polymeric compounds. By the process solutions of the polymeric imidazolium compounds are obtained. Such solutions may have a high concentration of the polymeric imidazolium compounds. The process does neither require compounds with halogen nor the use of mono-aldehydes such as formaldehyde. Hence the polymeric imidazolium compounds obtained by the process may be free of halogen and/or formaldehyde, if required.

### EXAMPLES

The molecular weight of the polymeric imidazolium compounds was determined by Size-exclusion chromatographie (SEC) using poly(2-vinylpyridine as standard and water comprising 0.1 w/w % trifluoracetic acid and 0.1 mol/1 NaCl as effluent. The temperature of the column was 25° C., the injected volume 100 μL (μliter), the concentration 1.5 mg/mL and the flow rate 0.8 mL/min.

The weight average molecular weight (Mw), the number average molecular weight (Mn) and the polydispersity PDI (Mw/Mn) of the polymeric imidazolium compounds obtained are specified in the examples.

The solid content of the product solutions obtained was determined by drying the solution under vacuum at 120° C. for two hours.

The nuclear magnetic resonance spectra (NMR) wereattaken of the product solutions as such. In the Annexes the NMR spectra of the examples are shown (chemical shift on the x-axis, intensity on the y-axis). The NMR spectra show peaks of the polymer, only. Hence the NMR spectra prove that the solutions obtained do not comprise unreacted starting materials and that all starting materials have reacted to polymer.

### Comparison Example

(Using Mono-Aldehyde According to WO 2010/072571)

2 mol acetic acid and 1 mol of 1,4 butane-diamine (dissolved in water) were placed in a flask. A mixture of 1 Mol formaldehyde (49% aq. solution) and 1 Mol glyoxal (40% aq. solution) were added at room temperature (ice bath cooling) to the reaction mixture. After completion of the addition the reaction mixture was heated to 95° C. for one hour.

An aqueous solution comprising a polymeric imidazolium compound was obtained. The solid content of the solution was 37.5% by weight.

Mw: 25200 g/mol Mn: 2910 g/mol; PDI: 6.5

### Example 1

(Using Two Mol of Glyoxal, No Mono-Amine)

2 mol acetic acid and 1 mol of 1,4 butane-diamine (dissolved in water) were placed in a flask. 2 Mol glyoxal (40% aq. solution) were added at room temperature (ice bath cooling) to the reaction mixture. After completion of the addition the reaction mixture was heated carefully to 75° C. for 50 min. Water was added to the solution and the mixture was cooled to room temperature.

An aqueous solution comprising a polymeric imidazolium compound was obtained. The solid content of the solution was 17.1% by weight.

Mw: 12800 g/mol; Mn: 1210 g/mol; PDI: 10.6

### Example 2

(Using 1 Mol Glyoxal and 1 Mol Glyoxylic Acid, No Mono-Amine)

2 mol acetic acid and 1 mol of 1,4 butane-diamine (dissolved in water) were placed in a flask. A mixture of 1 Mol glyoxilc acid (50% aq. solution) and 1 Mol glyoxal (40% aq. solution) were added at room temperature (ice bath cooling) to the reaction mixture. After completion of the addition the reaction mixture was heated carefully to 95° C. for 2 h, during this time CO₂ evolved from the reaction mixture.

An aqueous solution comprising a polymeric imidazolium compound was obtained.

Mw: 12900 g/mol; Mn: 2190 g/mol; PDI: 5.9

TABLE
compounds used in the examples

| | | Formal- | Glyoxylic | | Acetic |
|---|---|---|---|---|---|
| | Diamine | dehyde | acid | Glyoxal | acid |
| | (mol) | (mol) | (mol) | (mol) | (mol) |
| Comparison | 1,4-Diamino- | 1 mol | — | 1 mol | 2 mol |
| example | butane | | | | |
| | 1 mol | | | | |
| Example 1 | 1,4-Diamino- | — | — | 2 mol | 2 mol |
| | butane | | | | |
| | 1 mol | | | | |
| Example 2 | 1,4-Diamino- | — | 1 mol | 1 mol | 2 mol |
| | butane | | | | |
| | 1 mol | | | | |

Attached are three figures:

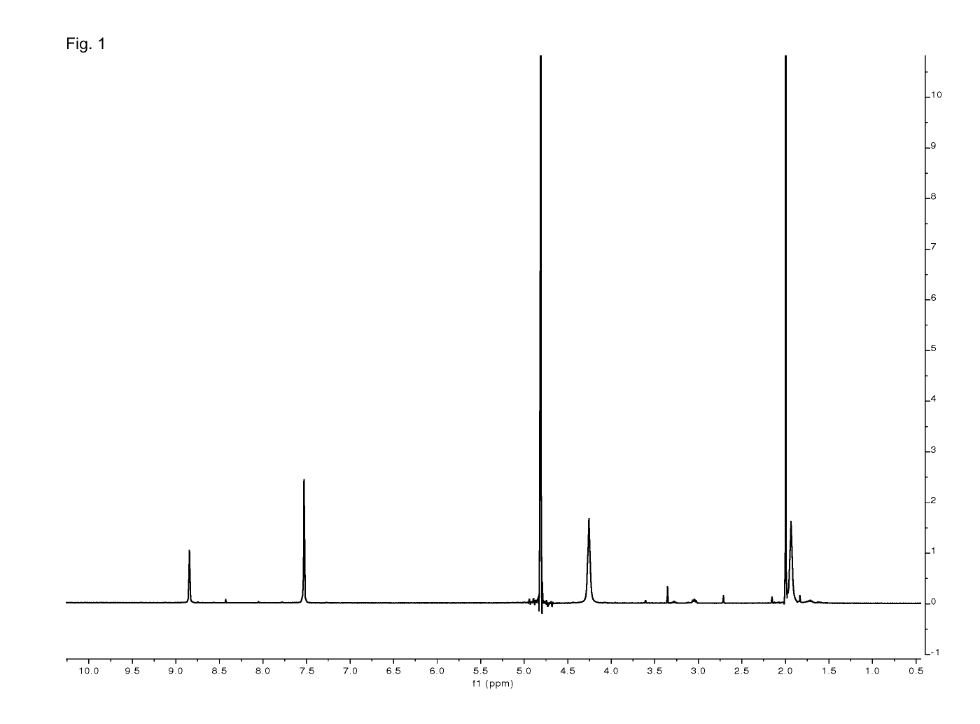

FIG. 1: 1H-NMR of polymer from the comparison example

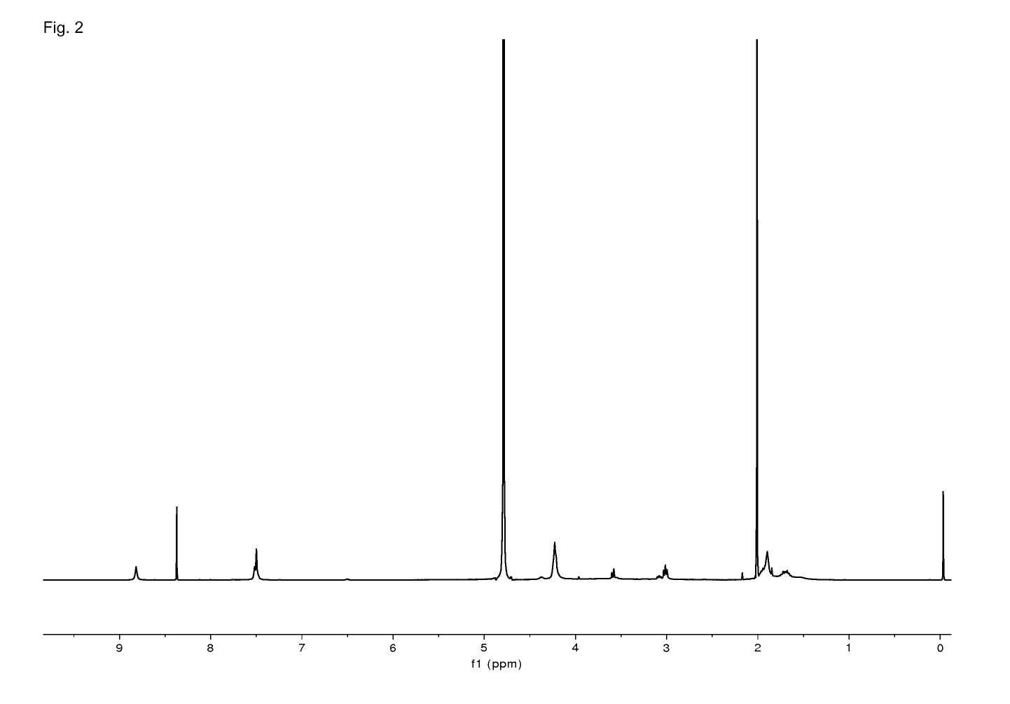

FIG. 2: 1H-NMR of polymer from example 1

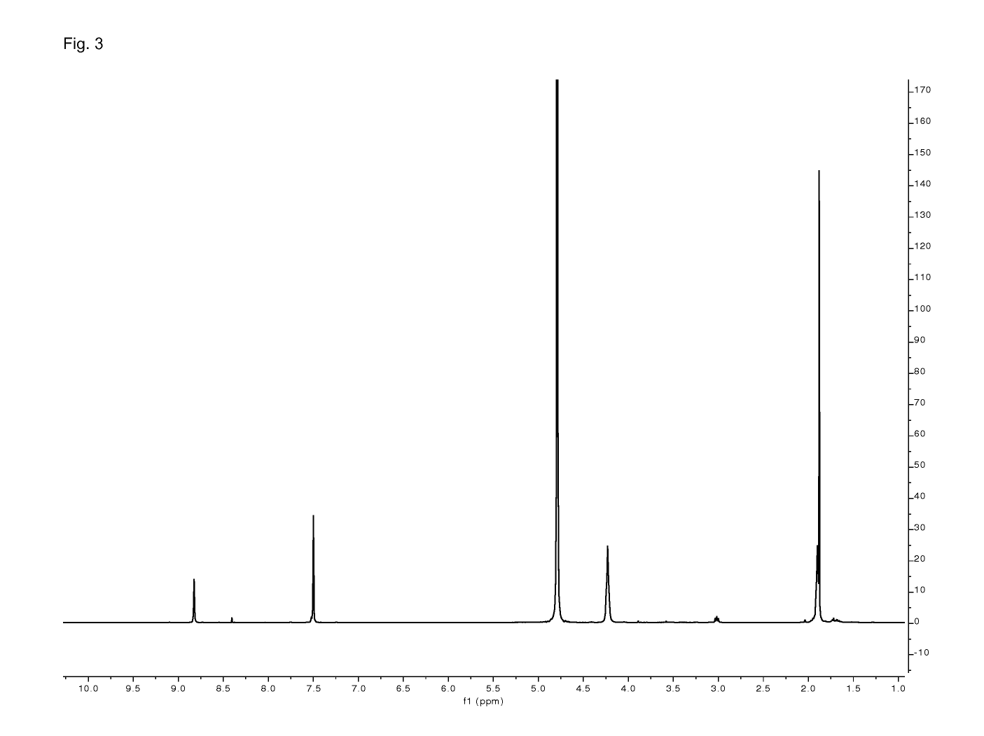

FIG. 3: 1H-NMR of polymer from example 2

1. A process for preparing a polymeric compound comprising ionic imidazolium groups, the process comprising
reacting a reaction mixture comprising
an α-dicarbonyl compound,
an oligoamine, which is an amino compound comprising at least two primary amino groups,
a protic acid,
less than 1 mol of a monoaldehyde, which is a compound with only one aldehyde group, per mol of the oligoamine, and
optionally further compounds
in a reactor.

2. The process according to claim 1, wherein less than 0.1 mol of the mono-aldehyde per mol the oligo-amine is used.

3. The process according to claim 1, wherein no mono-aldehyde is used.

4. The process according to claim 1, wherein the α-dicarbonyl compound is a compound or a mixture of compounds of formula I
R1-CO—CO—R2 (I)
wherein R1 and R2 are each, independently of one another, an H atom, a hydroxy group or an organic radical having from 1 to 20 carbon atoms.

5. The process according to claim 4, wherein R1 and R2 are each, independently of one another, an H atom or a hydroxyl group.

6. The process according to claim 1, wherein the α-dicarbonyl compound is glyoxal, glyoxylic acid or a mixture thereof.

7. The process according to claim 1, wherein the oligoamine is a compound of formula II
(NH2)ₙR3 (II)
where n is an integer greater than or equal to 2 and R3 is any n-valent organic radical.

8. The process according to claim 1, wherein the oligo-amine is an aliphatic or aromatic diamine or triamine.

9. The process according to claim 1, wherein the oligo-amine is a C2-C20-alkylenediamine.

10. The process according to claim 1, wherein the protic acid is an acid with a pKₐ greater than 1.

11. The process according to claim 1, wherein the protic acid is acetic acid.

12. The process according to claim 1, wherein the process is performed in water, a water-miscible solvent, or a mixture thereof.

13. The process according to claim 1, wherein said reacting occurs in a reaction solution with pH value of from 1 to 6.

14. The process according to claim 1, wherein the protic acid is introduced into the reactor first and the oligoamine, the α-dicarbonyl compound and optionally the mono-aldehyde are subsequently added in a rate so that temperature of the reaction mixture is kept below 30° C.
